(19) United States
(12) Patent Application Publication
(10) Pub. No.: US 2014/0073454 A1
(43) Pub. Date: Mar. 13, 2014

(54) GOLF BALL MANUFACTURING METHOD AND GOLF BALL

(71) Applicant: Toshiro Wachi, Sekishi (JP)

(72) Inventor: Toshiro Wachi, Sekishi (JP)

(73) Assignee: BRIDGESTONE SPORTS CO., LTD., Tokyo (JP)

(21) Appl. No.: 13/614,165

(22) Filed: Sep. 13, 2012

(51) Int. Cl. A63B 43/00; B05D 3/02; B05D 3/00

(52) U.S. Cl. 473/371; 427/299; 427/314

(57) ABSTRACT

The invention provides a method of manufacturing golf balls having covers of very high transparency, which method includes, prior to formation of the cover, a preformed body fabricating step wherein a temperature-responsive pigment that responds to a change in temperature by developing a color is included in or coated onto the preformed body. In this way, a preformed body that matches the cover to be formed can be easily and reliably identified from among a plurality of types of preformed bodies stored at a temporary storage place. The invention also provides golf balls having a construction suitable for carrying out such a manufacturing method. The invention enables golf balls of excellent visibility and stylishness to be efficiently produced.

### BACKGROUND OF THE INVENTION

The present invention relates to a method of manufacturing golf balls having a core, a cover and, optionally, one or more intermediate layer between the core and the cover. More particularly, the invention relates to a golf ball manufacturing method which can be advantageously employed to produce highly stylish golf balls having covers of high transparency. The invention additionally relates to golf balls having a construction suitable for carrying out such a manufacturing method.

Golf ball development has hitherto been focused primarily on improving the basic performance of the ball, such as the distance, controllability, durability and feel at impact. From the standpoint of visibility and other considerations, the color of the ball has been predominantly white, which is an expansive color.

However, the base of golfers has expanded recently to include also young adults and women, leading to a rise in demand for golf balls which not only satisfy the basic performance requirements, but also have a distinctive appearance and convey a sense of the golfer's individuality. In response to such a demand, golf balls having an unusual appearance, such as golf balls which change color when exposed to ultraviolet radiation (published U.S. Patent Application No. 2004/0266553), golf balls having the quality of changing color in response to changes in temperature (thermochromism) (U.S. Pat. No. 7,226,961 and JP-A 11-076463), and golf balls which use phosphorescent pigments (published U.S. Patent Application No. 2004/0266554), have hitherto been described by golf ball suppliers.

The present applicant earlier disclosed, in JP-A 2007-136171, a golf ball which, in order to enhance the visibility and stylishness of the ball, has the quality of changing color (photochromism) depending on the type of light that strikes the ball. The present applicant also earlier disclosed, in JP-A 2002-186685, a golf ball in which, for greater convenience to the user, a temperature history mark is applied to the surface of the ball using an irreversible or semi-irreversible temperature indicating paint, thus making it possible to determine the thermal history incurred by the ball during storage.

In addition, golf balls having a cover formed of transparent or translucent resin over either a core or a sphere composed of a core encased by one or more intermediate layer have been disclosed as highly stylish golf balls of distinctive appearance. Such golf balls often have a sense of transparency and leave the consumer with an impression of quality and elegance. By also mixing a pigment into the resin, colors of unprecedented vibrancy can be expressed.

However, in the foregoing golf balls having a highly transparent cover, the color tone of the ball is sometimes affected by the color of the layer in contact with the cover on the inside thereof (in the present invention, this layer refers to the core or the outermost intermediate layer, and is denoted below as the “layer adjacent to the cover”). For example, when a highly transparent material is used to form a cover over a core having a dark gray color, the color of the core ends up being visible through the cover. In such a case, even when the cover has been colored to some degree, the core color cannot be completely hidden; as a result, the color tone of the ball takes on a gray tinge. On the other hand, when large amounts of pigment, filler and the like are compounded in the above material in order to completely hide the color of the core, the resulting ball loses its transparent feel, making it difficult to achieve a vibrant color. In such cases, to reduce the influence that the color of the layer adjacent to the cover has on the ball color, it is common to make this layer white.

In order to respond to the diverse needs of the market, golf ball production at a manufacturing plant ordinarily involves the concurrent production of many types of golf balls of differing performance attributes such as distance and controllability. From a production control standpoint, the preformed body fabricated prior to formation of the cover is often transferred to a temporary storage place following fabrication and stored until such time as the cover is formed. The preformed body that matches a particular cover to be formed is then selected from among a plurality of types of preformed bodies stored at the temporary storage place, and supplied to the cover-forming step. In golf balls having a conventional white color, the preformed bodies can easily be distinguished from one another by varying the color of the preformed body for each type of ball. In the present invention, “preformed body” refers to a core or a sphere composed of a core encased by one or more intermediate layer. Also, the outermost layer of such a preformed body corresponds to the “layer adjacent to the cover” as defined above.

In golf balls having a highly transparent cover, to keep the color of the preformed body from affecting the ball color following cover formation, the preformed bodies are often made white, regardless of the type thereof. As a result, the preformed bodies stored at a temporary storage place, notwithstanding minor differences by type in such characteristics as diameter and weight, are substantially alike in appearance. Hence, when selecting preformed bodies to be supplied to the cover-forming step, it is difficult to distinguish between the different types based on their appearance. Up until now, the preformed body matching a cover to be formed has been identified and selected from a plurality of types by checking the diameter and weight each time, but such identification is time-consuming, lowering productivity. Moreover, if the wrong type of preformed body is selected, the result is a defective product.

Accordingly, in the production of the above-described golf balls having a highly transparent cover, from the standpoint of improving productivity, there exists a desire for a way to easily and reliably identify, from among preformed bodies of different types but the same color, a preformed body that matches the cover to be formed.

### SUMMARY OF THE INVENTION

It is therefore an object of the present invention to provide a golf ball manufacturing method which is capable of efficiently, and without detriment to the ball color, producing highly stylish golf balls having covers of very high transparency. Another object is to provide golf balls of a construction suitable for carrying out such a manufacturing method.

In order to achieve the above object, the inventors here disclose a method for manufacturing golf balls having covers of very high transparency. The method includes, prior to formation of the cover, a preformed body fabricating step in which a temperature-responsive pigment which develops a specific color in response to changes in temperature is included in or coated onto the preformed body. In this way, a preformed body that matches a cover to be formed can be easily and reliably identified from among a plurality of types of preformed bodies stored at a temporary storage place, enabling productivity to be increased. The inventors also disclose golf balls having a construction suitable for carrying out such a manufacturing method, which method is described below.

Accordingly, the invention provides the following golf ball manufacturing method and golf ball.

[1] A method of manufacturing a golf ball having a core, a cover and, optionally, one or more intermediate layer between the core and the cover, the method comprising the steps of:

fabricating a preformed body which is a core or a sphere comprising a core over which one or more intermediate layer has been formed;

transferring the preformed body to a temporary storage place;

selecting, from among a plurality of preformed bodies stored at the temporary storage place, a preformed body that matches a cover to be formed;

transferring the selected preformed body to a cover-forming step;

forming a cover over the preformed body transferred from the temporary storage place;

in the preformed body fabricating step, including in or coating onto the preformed body a temperature-responsive pigment that responds to a change in temperature by developing a color; and

in the preformed body selecting step, heating or cooling the preformed bodies stored at the temporary storage place so as to have the temperature-responsive pigment develop a color, and identifying by the color a preformed body that matches the cover to be formed.

[2] The golf ball manufacturing method of [1], wherein the preformed body is selected from the group consisting of:

cores formed of a material containing a temperature-responsive pigment;

spheres obtained by forming one or more intermediate layer over a core, wherein an outermost intermediate layer is formed of a material containing a temperature-responsive pigment;

cores coated on all or part of a surface thereof with a material containing a temperature-responsive pigment; and

spheres obtained by forming one or more intermediate layer over a core, wherein an outermost intermediate layer has been coated on all or part of a surface thereof with a material containing a temperature-responsive pigment.

[3] The golf ball manufacturing method of [1], wherein the temperature-responsive pigment is one or more selected from the group consisting of leuco dyes, spiropyran, polydiacetylene and salicylideneaniline.
[4] The golf ball manufacturing method of [1], wherein temperature-responsive microcapsules are used as the temperature-responsive pigment.
[5] The golf ball manufacturing method of [1], further including, in the step of selecting the preformed body using a temperature-responsive pigment which develops a color at a temperature below 10° C. or above 40° C., subjecting preformed bodies stored in a temporary storage place to cooling to a temperature below 10° C. or heating to a temperature above 40° C. so as to effect color development.
[6] A golf ball comprising a core, a cover and, optionally, one or more intermediate layer between the core and the cover, wherein a layer adjacent to an inner side of the cover (layer adjacent to the cover) is formed of a material containing a temperature-responsive pigment that responds to a change in temperature by developing a color.
[7] The golf ball of [6], wherein the layer adjacent to the cover is a core formed of a rubber composition, which rubber composition contains the temperature-responsive pigment in an amount of from 0.01 to 30 parts by weight per 100 parts by weight of a base rubber.
[8] The golf ball of [6], wherein the layer adjacent to the cover is an intermediate layer formed of a resin composition, which resin composition contains the temperature-responsive pigment in an amount of from 0.01 to 30 parts by weight per 100 parts by weight of a base resin.
[9] The golf ball of [6], wherein the temperature-responsive pigment is one or more selected from the group consisting of leuco dyes, spiropyran, polydiacetylene and salicylideneaniline.
[10] The golf ball of [6], wherein the temperature-responsive pigment is temperature-responsive microcapsules.
[11] The golf ball of [6], wherein the temperature-responsive pigment develops a color at a temperature below 10° C. or above 40° C.
[12] A golf ball comprising a core, a cover and, optionally, one or more intermediate layer between the core and the cover, wherein all or part of a surface of a layer adjacent to an inner side of the cover (layer adjacent to the cover) is coated with a paint containing a temperature-responsive pigment that responds to a change in temperature by developing a color.
[13] The golf ball of [12], wherein the paint is a urethane paint.
[14] The golf ball of [12], wherein the temperature-responsive pigment is one or more material selected from the group consisting of leuco dyes, spiropyran, polydiacetylene and salicylideneaniline.
[15] The golf ball of [12], wherein the temperature-responsive pigment is temperature-responsive microcapsules.
[16] The golf ball of [12], wherein the temperature-responsive pigment develops a color at a temperature below 10° C. or above 40° C.

### DETAILED DESCRIPTION OF THE INVENTION

The invention is described more fully below.

The inventive method of manufacturing golf balls is suitable for manufacturing golf balls having a core, a cover and, optionally, one or more intermediate layer between the core and the cover, and especially golf balls in which the cover is formed of a transparent or translucent material or a material obtained by compounding a colorant in a transparent or translucent material. This manufacturing method includes the steps of:

fabricating a core or a sphere composed of a core over which one or more intermediate layer has been formed (which core or sphere is referred to herein as a “preformed body”);

transferring the preformed body to a temporary storage place;

selecting, from among a plurality of preformed bodies stored at the temporary storage place, a preformed body that matches a cover to be formed;

transferring the selected preformed body to a cover-forming step; and

forming a cover over the preformed body transferred from the temporary storage place.

The manufacturing method of the invention further includes, in the preformed body fabricating step prior to formation of the cover: fabricating a preformed body in which has been included or on which has been coated a temperature-responsive pigment that responds to a change in temperature by developing a color; and, in the step of selecting, from among a plurality of preformed bodies stored at the temporary storage place, a preformed body that matches a cover to be formed: heating or cooling the preformed bodies stored at the temporary storage place so as to develop the color of the temperature-responsive pigment, and identifying by the color a preformed body to be supplied to the cover-forming step.

As with conventional golf balls, the construction of the golf ball manufactured by the method of the invention may be suitably set according the target performance, and is not subject to any particular limitation. That is, the golf ball may be, as appropriate, a two-piece solid golf ball obtained by forming a cover over a solid core, or a multi-piece solid golf ball which has a construction of three or more pieces and is obtained by forming one or more intermediate layer between the solid core and the cover.

In the step of fabricating a core or a sphere composed of a core over which one or more intermediate layer has been formed (preformed body), the core and intermediate layer may be fabricated by a known molding method such as compression molding or injection molding. The core and intermediate layer are described in detail below.

The core is obtained by vulcanizing a rubber composition composed primarily of a rubber material. Specifically, use may be made of a rubber composition containing, for example, a base rubber, a crosslinking initiator and a co-crosslinking agent.

The base rubber of the rubber composition is not subject to any particular limitation, although the use of polybutadiene is preferred. Preferred use may be made of cis-1,4 polybutadiene having a cis structure content of at least 40%. If so desired, in the base rubber, other rubbers such as natural rubber, polyisoprene rubber or styrene-butadiene rubber may be suitably compounded with the above polybutadiene. The golf ball rebound can be improved by increasing the amount of rubber components.

Preferred use may be made of an organic peroxide as the crosslinking initiator in the invention. Illustrative examples of suitable organic peroxides include 1,1-di(t-butylperoxy)cyclohexane, 1,1-bis-t-butylperoxy-3,3,5-trimethylcyclohexane, dicumyl peroxide, di(t-butylperoxy)-meta-diisopropylbenzene and 2,5-dimethyl-2,5-di-t-butylperoxyhexane. A commercial product may be used as the organic peroxide. Examples of such products include Perhexa C-40, Perhexa 3M-40 and Percumyl D (all available from NOF Corporation) and Trigonox 29-40 (available from Kayaku Akzo Corporation). These crosslinking initiators are compounded in an amount which, although not subject to any particular limitation, may be set to at least 0.1 part by weight, and preferably at least 0.3 part by weight, per 100 parts by weight of the base rubber.

The upper limit may be set to not more than 5 parts by weight, and preferably not more than 2 parts by weight.

The co-crosslinking agent used in the invention may be, for example, a metal salt of an unsaturated fatty acid such as methacrylic acid or acrylic acid (e.g., zinc salts, magnesium salts, calcium salts), or an ester compound such as trimethylolpropane trimethacrylate. To obtain a high rebound in particular, preferred use may be made of zinc acrylate. The amount of such co-crosslinking agents included per 100 parts by weight of the base rubber, although not subject to any particular limitation, may be set to at least 10 parts by weight, and preferably at least 15 parts by weight, but not more than 50 parts by weight, and preferably not more than 40 parts by weight.

In addition, various types of additives may be optionally included in the above composition, examples of such additives being sulfur, antioxidant, zinc oxide, barium sulfate, the zinc salt of pentachlorothiophenol and zinc stearate. No particular limitation is imposed on the amounts in which these additives are included.

The core diameter, although not subject to any particular limitation, may be set to preferably at least 32.0 mm, and more preferably at least 33.0 mm, but preferably not more than 40.5 mm, and more preferably not more than 39.5 mm.

The core has a deflection when compressed under a final load of 1,275 N (130 kgf) from an initial load of 98 N (10 kgf) which, although not subject to any particular limitation, may be set in a range of from 2.5 to 5.0 mm, preferably from 3.0 to 4.5 mm, and more preferably from 3.5 to 4.0 mm. If the core deflection is too small, the feel of the ball at impact when struck with a driver may be too hard and the scuff resistance may worsen. On the other hand, if the core deflection is too large, the feel when struck with a driver may be too soft and the distance traveled by the ball may decrease markedly.

The rubber composition may be prepared by using a known mixer (e.g., a Banbury mixer, kneader, or roll mill) to mix each of the above ingredients. Moreover, a known method such as compression molding may be advantageously employed to form a solid core using the rubber composition prepared as described above.

The description thus far is the same as for a conventional core. However, in cases where the above core is to be used as a preformed body, in order to carry out the manufacturing method of the invention, it is critical for all or part of the core surface to respond to a change in temperature by developing a specific color. The means for having the above core respond to a change in temperature by developing a specific color is described below. In this case, the color of the core is white at normal temperatures (“Normal temperatures” refers here to the room temperatures that can be expected in ordinary indoor workplaces, the range in such temperatures being generally from 10 to 40° C. The same applies below.) Also, the resulting golf ball is a two-piece solid golf ball having a single cover layer formed over the core.

In the present invention, a temperature-responsive pigment is used in order to have the core (preformed body), which appears white at normal temperatures, respond to a change in temperature by developing a specific color. This temperature-responsive pigment, when subjected to a change in temperature, reversibly changes color from a colorless to a colored state. It is preferable to select as the temperature-responsive pigment in this invention a pigment which is little affected by air temperature fluctuations such as day-and-night fluctuations or seasonal fluctuations and, from the standpoint of obtaining a stable color change, is colorless at normal temperatures (about 10 to 40° C.), but which develops a color at temperatures below 10° C. or above 40° C. Moreover, it is recommended that a temperature-responsive pigment which develops a color at temperatures of 45° C. or above be selected.

Exemplary temperature-responsive pigments include leuco dyes, spiropyran, polydiacetylene and salicylideneaniline. In the practice of the invention, from the standpoint of light resistance, preferred use may be made of temperature-responsive microcapsules composed of a temperature-responsive pigment enclosed within capsule shells having a diameter of from about 1 to about 1,000 μm. Commercial products may be used as such temperature-responsive pigments. For example, preferred use may be made of the products available as Temperature-Responsive Capsules: Red, Orange, Black, Blue, Green, and Emerald Green (from Chemitech Inc.), and the products available as Temperature-Indicating Capsules: Red, Yellow, Blue, and Green (from Dyrec KK).

Use of the above temperature-responsive pigments in the manufacturing method of the invention may be carried out by compounding the temperature-responsive pigment in the above rubber composition, or by coating all or part of the surface of a core fabricated of the above-described rubber composition (containing no temperature-responsive pigment) with a paint containing the temperature-responsive pigment.

When the temperature-responsive pigment is compounded in the above rubber composition, the required amount thereof may be suitably compounded in the same way as the other ingredients of the rubber composition. The amount of temperature-responsive pigment included, although not subject to any particular limitation, may be set to preferably at least 0.01 part by weight, and more preferably at least 0.1 part by weight, per 100 parts by weight of the base rubber. The upper limit is preferably not more than 30 parts by weight, more preferably not more than 10 parts by weight, and even more preferably not more than 5 parts by weight, per 100 parts by weight of the base rubber. If too little temperature-responsive pigment is included, color development when the temperature has changed will be weak, which may make a distinguishability improving effect difficult to achieve. On the other hand, including too much temperature-responsive pigment may lead to increased costs or may have undesirable effects on the ball properties.

In cases where all or part of the core surface is coated, the paint used is not subject to any particular limitation, although the use of a urethane paint is preferred in the present invention. In this case, the amount of temperature-responsive pigment included with respect to the paint is set in a range of preferably from 0.1 to 50 parts by weight, and more preferably from 0.5 to 30 parts by weight, per 100 parts by weight of the paint resin. If too little temperature-responsive pigment is included, color development when the temperature has changed will be weak, which may make a distinguishability improving effect difficult to achieve. On the other hand, including too much temperature-responsive pigment may lead to increased costs or have undesirable effects on the ball properties.

The coating method is not subject to any particular limitation. For example, a known method such as spray painting or brush painting may be used. Alternatively, if only part of the core surface is to be coated, markings in the form of suitable letters, numbers, symbols and the like may be applied with the above paint. In cases where markings are applied, the method for doing so is not subject to any particular limitation, although a known method such as pad printing or masking and painting may be used. To increase adhesion of the paint to the core, the surface of the core may be subjected to some form of pretreatment, such as blasting, primer treatment, plasma treatment or corona discharge treatment.

The core (preformed body) which has been fabricated in this way is white at normal temperatures. However, when the core is heated or cooled, all or part of the surface develops a specific color that depends on the type of temperature-responsive pigment. Hence, even when a plurality of types of preformed bodies are stored at a temporary storage place, heating or cooling the bodies using a know heating means or cooling means causes them to develop a specific color, enabling the preformed bodies to be easily and reliably identified by the resulting color tone or the lettering or other markings that appear. Examples of such heating means and cooling means include heating means such as a dryer or heater, cooling means such as a spot cooler or refrigerator, and means capable of both heating and cooling such as a thermostatic chamber. Because the preformed body does not develop a color and remains white at normal temperatures, it does not influence the color of the ball following cover formation.

In the present invention, the intermediate layer is a layer which is optionally formed between the core and the cover. In cases where the golf ball to be manufactured has an intermediate layer, the preformed body is a sphere obtained by forming one or more intermediate layer over a core. The resulting golf ball is a multi-piece solid golf ball having a structure composed of three or more pieces. No particular limitation is imposed on the method of molding the intermediate layer, although use may be made of a known molding method such as injection molding or compression molding. For example, when injection molding is carried out, the fabricated core may be set in a mold and, in accordance with ordinary practice, an intermediate layer-forming material may be injected into the mold. In cases where the intermediate layer described above is formed, there is no particular need to use a temperature-responsive pigment in the solid core.

A thermoplastic resin or a thermoplastic elastomer may be preferably used as the base resin in the intermediate layer-forming material. Exemplary thermoplastic resins include ionomer resins. A commercial product may be used as the ionomer resin. Illustrative examples of commercial ionomer resins that may be used in the practice of the invention include Himilan resins (available from DuPont-Mitsui Polychemicals Co., Ltd.), Surlyn resins (from E.I. DuPont de Nemours & Co.) and Iotek (from Exxon). Illustrative examples of thermoplastic elastomers include polyester-type thermoplastic elastomers, polyamide-type thermoplastic elastomers, polyurethane-type thermoplastic elastomers, olefin-type thermoplastic elastomers, and styrene-type thermoplastic elastomers. A commercial product may be used as the thermoplastic elastomer. Illustrative examples of commercial thermoplastic elastomers that may be used in the practice of the invention include Hytrel resins (available from DuPont-Toray Co., Ltd.), Pelprene (from Toyobo Co., Ltd.), Pebax (from Toray Industries, Inc.), Pandex (from DIC Corporation), Santoprene (from Monsanto Chemical Co.,), Tuftec (from Asahi Chemical Industry Co., Ltd.), and Dynaron (from JSR Corporation). In this invention, preferred use may be made of an ionomer resin or a thermoplastic polyurethane elastomer as the above thermoplastic resin or thermoplastic elastomer.

When a thermoplastic resin is used as the base resin, although not subject to any particular limitation, the melt flow index of the thermoplastic resin is preferably at least 0.5 g/10 min. The thermoplastic resin has a material hardness, expressed as the Shore D hardness, which, although not subject to any particular limitation, is preferably at least 40. Here, “material hardness” refers to the hardness of a 2 mm-thick sheet obtained by press-molding the material to be measured, which hardness is measured using a type D durometer in general accordance with ASTM D2240. Moreover, although not subject to any particular limitation, the material has a rebound resilience, as measured in general accordance with JIS K 7311, of preferably at least 30%.

The intermediate layer has a material hardness, expressed as the Shore D hardness, which, although not subject to any particular limitation, is preferably at least 45, and more preferably at least 48. The upper limit in the Shore D hardness is preferably not more than 55, and more preferably not more than 53. If the material hardness of the intermediate layer is too low, the ball rebound may be poor, possibly lowering the distance of the ball. On the other hand, too high a material hardness may worsen the feel at impact or worsen the scuff resistance.

The thickness of the intermediate layer, although not subject to any particular limitation, may be set to preferably at least 0.8 mm, and more preferably at least 1.2 mm. The upper limit in thickness is preferably not more than 2.2 mm, and more preferably not more than 1.8 mm. If the intermediate layer is too thin, the durability to cracking on repeated impact may worsen. On the other hand, if the intermediate layer is too thick, the ball rebound may decrease, resulting in a shorter distance.

In the manufacturing method of the invention, a temperature-responsive pigment is used in order to have a preformed body (a sphere obtained by forming one or more intermediate layer over the above-described core) which appears white at normal temperatures develop a specific color when heated or cooled. The temperature-responsive pigment used for this purpose may be of the same type as those mentioned above by way of example.

In the manufacturing method of the invention, the temperature-responsive pigment may be used by employing a method wherein the temperature-responsive pigment is compounded in the above-described intermediate layer-forming resin material, or by a method wherein all or part of the surface of the sphere obtained by using the above resin material (containing no temperature-responsive pigment) to form an intermediate layer over the core is coated with a paint containing the temperature-responsive pigment.

When a temperature-responsive pigment is compounded in the above resin material, it may be suitably compounded in the required amount in the same way as the other ingredients of the resin material. The amount included, although not subject to any particular limitation, may be set to preferably at least 0.01 part by weight, and more preferably at least 0.1 part by weight, per 100 parts by weight of the base resin. The upper limit is preferably not more than 30 parts by weight, more preferably not more than 10 parts by weight, and even more preferably not more than 5 parts by weight, per 100 parts by weight of the base resin. If the amount of temperature-responsive pigment included is too small, color development when the temperature has changed will be weak, which may make a distinguishability improving effect difficult to obtain. On the other hand, including too much temperature-responsive pigment may lead to increased costs or may have undesirable effects on the ball properties. If a plurality of intermediate layers are to be formed, the temperature-responsive pigment should be included in the outermost of the intermediate layers (i.e., the layer adjacent to the cover).

In cases where a method is used wherein all or part of the surface of the sphere (preformed body) obtained by forming one or more intermediate layer over a core is coated with a paint containing a temperature-responsive pigment, any of the above-described methods may be employed as the coating method.

The preformed body (sphere obtained by forming one or more intermediate layer over a core) is white at normal temperatures, but when heated or cooled, all or part of the surface develops a specific color that depends on the type of temperature-responsive pigment. Hence, even when a plurality of types of preformed bodies are stored at a temporary storage place, heating or cooling the preformed bodies using a known heating means or cooling means causes them to develop a specific color, enabling the preformed bodies to be easily and reliably identified by the resulting color tone or the lettering or other markings that appear. Examples of such heating means and cooling means include heating means such as a dryer or heater, cooling means such as a spot cooler or refrigerator, and means capable of both heating and cooling such as a thermostatic chamber. Because the preformed body does not develop a color and remains white at normal temperatures, it does not influence the color of the ball following cover formation.

The preformed body fabricated as described above (which body is a core or a sphere composed of a core over which one or more intermediate layer has been formed) is then transferred to a temporary storage place and there stored until such time as it is to be supplied to the subsequently described cover-forming step. Numerous white preformed bodies of differing types are stored at the same temporary storage place. When a preformed body is needed, the stored preformed bodies are heated or cooled, causing them to develop specific colors. A preformed body matching the cover to be formed is then identified and selected by the color, and transferred to the cover-forming step.

The cover is the layer formed on the outermost side of the golf ball, and typically has a large number of dimples formed on the surface thereof. The cover is described in detail below.

A thermoplastic resin or a thermoplastic elastomer may be advantageously used as the base resin in the cover-forming material. Exemplary thermoplastic resins include ionomer resins. A commercial product may be used as the ionomer resin. Illustrative examples of commercial ionomer resins that may be used in the invention include Himilan resins (available from DuPont-Mitsui Polychemicals Co., Ltd.), Surlyn resins (from E.I. DuPont de Nemours & Co.) and Iotek (from Exxon). Illustrative examples of thermoplastic elastomers include polyester-type thermoplastic elastomers, polyamide-type thermoplastic elastomers, polyurethane-type thermoplastic elastomers, olefin-type thermoplastic elastomers, and styrene-type thermoplastic elastomers. A commercial product may be used as the thermoplastic elastomer. Illustrative examples of commercial thermoplastic elastomers that may be used in the practice of the invention include Hytrel resins (available from DuPont-Toray Co., Ltd.), Pelprene (from Toyobo Co., Ltd.), Pebax (from Toray Industries, Inc.), Pandex (from DIC Corporation), Santoprene (from Monsanto Chemical Co.,), Tuftec (from Asahi Chemical Industry Co., Ltd.), and Dynaron (from JSR Corporation). In the practice of this invention, preferred use may be made of an ionomer resin or a thermoplastic polyurethane elastomer as the above thermoplastic resin or thermoplastic elastomer.

In cases where a thermoplastic resin is used as the base resin, although not subject to any particular limitation, the thermoplastic resin has a melt flow index of preferably at least 0.5 g/10 min. The thermoplastic resin has a material hardness, expressed as the Shore D hardness, which, although not subject to any particular limitation, is preferably at least 40. Moreover, although not subject to any particular limitation, the material has a rebound resilience, as measured in general accordance with JIS K 7311, of preferably at least 30%.

A transparent resin or translucent resin is preferably used as the base resin of the cover material. Moreover, the cover material may be colored by the suitable addition of colorants such as known fluorescent agents, pigments and dyes so as to give the ball a vibrant color.

Examples of such colorants include, but are not limited to, light-harvesting dyes (pink), Solvent Yellow dyes, Solvent Orange dyes, anthraquinone dyes, phthalocyanine dyes, yellow fluorescent pigments, pink fluorescent pigments and orange fluorescent pigments. Known commercial products may be used as these colorants.

The above colorants are included in an amount which, although not subject to any particular limitation, is preferably in a range of from 0.001 to 10 parts by weight per 100 parts by weight of the base resin. By keeping the amount of colorant within this range, the resistance of the overall ball to discoloration can be improved.

Inorganic fillers such as titanium oxide may be included within a range that is not detrimental to the cover transparency. The amount of such inorganic fillers, although not subject to any particular limitation, may be set to from 0.01 to 5 parts by weight per 100 parts by weight of the base resin.

Insofar as there is no loss of cover transparency, the cover material may also suitably include various additives other than the above-described inorganic fillers, such as ultraviolet absorbers, antioxidants and metal soaps.

The cover material may be conferred which a hardness, expressed as the Shore D hardness, which, although not subject to any particular limitation, is generally at least 40, and preferably at least 43. The upper limit in the Shore D hardness is generally not more than 62, and preferably not more than 60. If the material hardness is too high, a suitable spin rate may be difficult to achieve on approach shots, which may result in a poor controllability. On the other hand, if the material hardness is too low, the ball rebound may worsen, possibly shortening the distance of the ball.

The cover hardness, although not subject to any particular limitation, may be set to generally at least 0.5 mm, and preferably at least 0.8 mm. The upper limit is generally not more than 3.0 mm, and preferably not more than 2.2 mm. If the cover is too thin, a suitable spin performance may be difficult to achieve, or the durability to cracking on repeated impact may worsen. On the other hand, if the cover is too thick, the ball rebound may decrease, resulting in a shorter distance.

A known molding method such as injection molding or compression molding may be employed to form the cover over the preformed body using the above cover material. For example, in cases where injection molding is carried out, the preformed body that has been fabricated may be set within a mold and, in accordance with ordinary practice, the above cover material may be injected into the mold.

Numerous dimples are generally formed on the surface of the cover that has been formed in the above manner. In addition, the surface of the cover may, for example, be clear coated and have markings applied thereto.

In cases where markings are applied to the surface of the cover, a commonly used method may be employed for this purpose. Illustrative examples include directing printing methods which include a pad printing step; and indirect printing methods such as a transfer method in which a stamp presses a transfer film with a solid covering of ink against the ball, a method in which ink is cast onto surface features (stamped areas, etc.) on the surface of the ball proper, and thermal transfer printing. The type, position and number of markings placed on the cover surface are not subject to any particular limitation. For example, markings such as letters, numbers, trade names and logos may be applied at any position on the ball. To increase adhesion between the markings and the cover, the surface of the ball cover may be subjected to some kind of pretreatment, such as blasting, primer treatment, plasma treatment or corona discharge treatment, prior to application of the markings.

The paint used is not subject to any particular limitation, although the use of a urethane paint is generally preferred. The amount of colorant included in the paint, although not particularly limited, may be set to generally from 0.1 to 50 parts by weight, and preferably from 0.5 to 30 parts by weight, per 100 parts by weight of the paint resin.

The golf ball formed as described above has a deflection, when compressed under a final load of 1,275 N (130 kgf) from an initial load state of 98 N (10 kgf), which, although not subject to any particular limitation, may be set to preferably at least 2.0 mm, more preferably at least 2.3 mm, and even more preferably at least 2.5 mm. The upper limit is preferably not more than 4.0 mm, more preferably not more than 3.5 mm, and even more preferably not more than 3.2 mm. If the ball deflection is too small, the feel on impact may be poor or, particularly on shots with an iron, the spin rate may rise excessively, possibly resulting in a large decrease in distance. On the other hand, if the ball deflection is too large, the ball rebound may be poor, resulting in a decreased distance, particularly on shots with a driver.

Golf balls manufactured by the method of the invention may be formed, in accordance with the Rules of Golf, to a diameter of preferably not less than 42.67 mm and a weight of preferably not more than 45.93 g.

As explained above, the inventive method of manufacturing golf balls can be suitably employed in cases where golf balls having a cover of very high transparency are to be produced. The inventive method includes, prior to formation of the cover, a preformed body fabricating step in which a temperature-responsive pigment that responds to a change in temperature by developing a specific color is included in or coated onto the preformed body. In this way, a preformed body that matches a cover to be formed can be easily and reliably identified from among a plurality of types of preformed bodies stored at a temporary storage place. This manufacturing method enables golf balls of excellent visibility and stylishness to be efficiently produced.

### EXAMPLES

The manufacturing method of the invention is illustrated more fully below by way of the following Examples, although these Examples are not intended to limit the invention.

### Examples 1 to 4, Comparative Examples 1 to 4

First, the core-forming rubber compositions shown in Table 1 were prepared in accordance with ordinary practice, and the resulting compositions were vulcanized at 155° C. for 15 minutes, thereby fabricating solid cores having a diameter of 38.7 mm. At this time, Temperature-Responsive Capsules (Green) which develop a green color at 45° C. and above were included as the temperature-responsive pigment in the cores of Examples 1 and 2, and Temperature-Responsive Capsules (Orange) which develop an orange color at 45° C. and above were included as the temperature-responsive pigment in the cores of Examples 3 and 4. These cores were all white at normal temperatures. In addition, the cores in Comparative Examples 1 and 3 were fabricated by excluding the temperature-responsive pigment from the formulations in the above examples of the invention, and the cores in Comparative Examples 2 and 4 were fabricated by including a blue pigment instead of a temperature-responsive pigment.

Next, using the materials formulated as shown in Table 1, in accordance with ordinary practice, covers having a thickness of 2 mm were injection-molded over the cores fabricated as described above, thereby producing two-piece solid golf balls. The balls obtained in Examples 1 to 4 and Comparative Examples 1 and 2 were colored golf balls in which a yellow cover was formed. The balls obtained in Comparative Examples 3 and 4 were golf balls in which an ordinary white cover was formed over the core under the same conditions as in, respectively, Comparative Examples 1 and 2.

Using the core and ball obtained in Comparative Example 1 as controls, the core distinguishability and the ball color (appearance) were evaluated for each of the cores and balls manufactured as described above. Evaluation of the core distinguishability was carried out by heating a fabricated core with a heater so as to bring about color development, then comparing the core with the control core and the cores in the other examples of the invention. Cores confirmed to have a clear color difference and to be easily distinguishable were rated as excellent (“Exc”), and cores confirmed to have a color difference and to be distinguishable were rated as “Good.” In evaluations of the ball appearance, balls which had no difference in color compared with the control ball were rated as “Good,” and balls which had a different color were rated as “NG.”

As a result, it was possible to identify each of the cores in Examples 1 to 4 from among a large number of mixed white cores by their color tone and relative intensity of color when heated to 45° C. Moreover, the balls in each of Examples 3 to 6 had a highly transparent and vibrant yellow color; because these balls had the same color tone as the control ball, the appearance of the ball in each of these examples was rated as “Good.” Because the core in Comparative Example 2 was colored blue and was therefore easily distinguishable, it had a distinguishability rating of “Exc.” However, owing to the influence of the core color, the ball obtained after cover formation on the same core had a dark yellow color tone. Therefore, the desired appearance could not be obtained, and so the ball appearance was rated as “NG.” The balls in Comparative Examples 3 and 4 are balls having conventional white covers formed thereon. It can be confirmed from the results in Table 3 that the core color in these cases had no influence on the color tone of the ball following cover formation.

TABLE 1

| | | | | Example | | | | Comparative Example | | | |
|---|---|---|---|---|---|---|---|---|---|---|---|
| | | | | 1 | 2 | 3 | 4 | 1 | 2 | 3 | 4 |
| Formulation | Core | Polybutadiene rubber | | 100 | 100 | 100 | 100 | 100 | 100 | 100 | 100 |
| (pbw) | | Organic Peroxide 1 | | 0.3 | 0.3 | 0.3 | 0.3 | 0.3 | 0.3 | 0.3 | 0.3 |
| | | Organic Peroxide 2 | | 0.3 | 0.3 | 0.3 | 0.3 | 0.3 | 0.3 | 0.3 | 0.3 |
| | | Antioxidant | | 0.1 | 0.1 | 0.1 | 0.1 | 0.1 | 0.1 | 0.1 | 0.1 |
| | | Zinc oxide | | 20 | 20 | 20 | 20 | 20 | 20 | 20 | 20 |
| | | Zinc acrylate | | 33 | 33 | 33 | 33 | 33 | 33 | 33 | 33 |
| | | Resino Blue | | | | | | | 0.01 | | 0.01 |
| | | Temperature-Responsive | | 0.01 | 0.1 | | | | | | |
| | | Capsules (Green) | | | | | | | | | |
| | | Temperature-Responsive | | | | 0.01 | 0.1 | | | | |
| | | Capsules (Orange) | | | | | | | | | |
| | Cover | Pandex T8295 | | 50 | 50 | 50 | 50 | 50 | 50 | 50 | 50 |
| | | Pandex T8260 | | 50 | 50 | 50 | 50 | 50 | 50 | 50 | 50 |
| | | Polyethylene wax | | 1 | 1 | 1 | 1 | 1 | 1 | 1 | 1 |
| | | Titanium oxide | | | | | | | | 3 | 3 |
| | | Yellow pigment | | 5 | 5 | 5 | 5 | 5 | 5 | | |
| Evaluation | Core | Color | 23° C. | white | white | white | white | white | blue | white | blue |
| | | | 45° C. | light | green | light | orange | white | blue | white | blue |
| | | | | green | | orange | | | | | |

| | | | | | | | | | |
|---|---|---|---|---|---|---|---|---|---|
| | Distinguishability | Good | Exc | Good | Exc | control | Exc | — | — |
| Ball | Color | yellow | yellow | yellow | yellow | yellow | dark | white | white |
| | | | | | | | yellow | | |
| | Appearance | Good | Good | Good | Good | control | NG | — | — |

Details of the ingredients in Table 1 are given below.

Polybutadiene rubber: Available under the trade name “BR01” from JSR Corporation; cis-1,4 bond content, 96%; Mooney viscosity (ML₁₊₄(100° C.)), 44; molecular weight distribution Mw/Mn, 4.2; nickel catalyst; solution viscosity, 150 mP·s.

Organic Peroxide 1: 1,1-Bis(t-butylperoxy)-3,3,5-trimethyl-siloxane, available under the trade name “Perhexa 3M-40” from NOF Corporation. Perhexa 3M-40 is a 40% dilution.

Organic Peroxide 2: Dicumyl peroxide, available under the trade name “Percumyl D” from NOF Corporation.

Antioxidant: 2,2′-Methylenebis(4-methyl-6-t-butyl-phenol), available under the trade name “Nocrac NS-6” from Ouchi Shinko Chemical Industry Co., Ltd.

Zinc oxide: Available from Sakai Chemical Co., Ltd.

Zinc acrylate: Available from Nihon Jyoryu Kogyo Co., Ltd.

Resino Blue: Available under the trade name “RT-6 (LB)” from Resino Color Industry Co., Ltd.

Temperature-Responsive Capsules (Green): Temperature-responsive microcapsules having an average particle size of about 2 to 5 μm (secondary particle size, about 30 μm) and containing a temperature-responsive pigment (dry powder) prepared so as to develop a green color at 45° C. and above. Available under the trade name “Temperature-Responsive Capsules: Green” from Chemitech Inc.

Temperature-Responsive Capsules (Orange): Temperature-responsive microcapsules having an average particle size of about 2 to 5 μm (secondary particle size, about 30 μm) and containing a temperature-responsive pigment (dry powder) prepared so as to develop an orange color at 45° C. and above. Available under the trade name “Temperature-Responsive Capsules: Orange” from Chemitech Inc.

Pandex: A MDI-PTMG type thermoplastic polyurethane elastomer available from DIC Bayer Polymer.

Polyethylene wax: Available under the trade name “Sanwax 161P” from Sanyo Chemical Industries, Ltd.

Titanium oxide: Available under the trade name “Tipaque R550” from Ishihara Sangyo Kaisha, Ltd.

Yellow pigment: Available under the trade name “Resino Yellow 3GR #55” from Resino Color Industry Co., Ltd.

1. A method of manufacturing a golf ball having a core, a cover and, optionally, one or more intermediate layer between the core and the cover, the method comprising the steps of:
fabricating a preformed body which is a core or a sphere comprising a core over which one or more intermediate layer has been formed;
transferring the preformed body to a temporary storage place;
selecting, from among a plurality of preformed bodies stored at the temporary storage place, a preformed body that matches a cover to be formed;
transferring the selected preformed body to a cover-forming step;
forming a cover over the preformed body transferred from the temporary storage place;
in the preformed body fabricating step, including in or coating onto the preformed body a temperature-responsive pigment that responds to a change in temperature by developing a color; and
in the preformed body selecting step, heating or cooling the preformed bodies stored at the temporary storage place so as to have the temperature-responsive pigment develop a color, and identifying by the color a preformed body that matches the cover to be formed.

2. The golf ball manufacturing method of claim 1, wherein the preformed body is selected from the group consisting of:
cores formed of a material containing a temperature-responsive pigment;
spheres obtained by forming one or more intermediate layer over a core, wherein an outermost intermediate layer is formed of a material containing a temperature-responsive pigment;
cores coated on all or part of a surface thereof with a material containing a temperature-responsive pigment; and
spheres obtained by forming one or more intermediate layer over a core, wherein an outermost intermediate layer has been coated on all or part of a surface thereof with a material containing a temperature-responsive pigment.

3. The golf ball manufacturing method of claim 1, wherein the temperature-responsive pigment is one or more selected from the group consisting of leuco dyes, spiropyran, polydiacetylene and salicylideneaniline.

4. The golf ball manufacturing method of claim 1, wherein temperature-responsive microcapsules are used as the temperature-responsive pigment.

5. The golf ball manufacturing method of claim 1, further including, in the step of selecting the preformed body using a temperature-responsive pigment which develops a color at a temperature below 10° C. or above 40° C., subjecting preformed bodies stored in a temporary storage place to cooling to a temperature below 10° C. or heating to a temperature above 40° C. so as to effect color development.

6. A golf ball comprising a core, a cover and, optionally, one or more intermediate layer between the core and the cover, wherein a layer adjacent to an inner side of the cover (layer adjacent to the cover) is formed of a material containing a temperature-responsive pigment that responds to a change in temperature by developing a color.

7. The golf ball of claim 6, wherein the layer adjacent to the cover is a core formed of a rubber composition, which rubber composition contains the temperature-responsive pigment in an amount of from 0.01 to 30 parts by weight per 100 parts by weight of a base rubber.

8. The golf ball of claim 6, wherein the layer adjacent to the cover is an intermediate layer formed of a resin composition, which resin composition contains the temperature-responsive pigment in an amount of from 0.01 to 30 parts by weight per 100 parts by weight of a base resin.

9. The golf ball of claim 6, wherein the temperature-responsive pigment is one or more selected from the group consisting of leuco dyes, spiropyran, polydiacetylene and salicylideneaniline.

10. The golf ball of claim 6, wherein the temperature-responsive pigment is temperature-responsive microcapsules.

11. The golf ball of claim 6, wherein the temperature-responsive pigment develops a color at a temperature below 10° C. or above 40° C.

12. A golf ball comprising a core, a cover and, optionally, one or more intermediate layer between the core and the cover, wherein all or part of a surface of a layer adjacent to an inner side of the cover (layer adjacent to the cover) is coated with a paint containing a temperature-responsive pigment that responds to a change in temperature by developing a color.

13. The golf ball of claim 12, wherein the paint is a urethane paint.

14. The golf ball of claim 12, wherein the temperature-responsive pigment is one or more material selected from the group consisting of leuco dyes, spiropyran, polydiacetylene and salicylideneaniline.

15. The golf ball of claim 12, wherein the temperature-responsive pigment is temperature-responsive microcapsules.

16. The golf ball of claim 12, wherein the temperature-responsive pigment develops a color at a temperature below 10° C. or above 40° C.
